(19) United States
(12) Patent Application Publication
(10) Pub. No.: US 2011/0121179 A1
(43) Pub. Date: May 26, 2011

(54) X-RAY WINDOW WITH BERYLLIUM SUPPORT STRUCTURE

(76) Inventors: STEVEN D. LIDDIARD, SPRINGVILLE, UT (US); KEITH W. DECKER, PLEASANT GROVE, UT (US); DEGAO XU, PROVO, UT (US)

(21) Appl. No.: 12/783,707

(22) Filed: May 20, 2010

Related U.S. Application Data
(63) Continuation-in-part of application No. 11/756,946, filed on Jun. 1, 2007, now Pat. No. 7,737,424.

(51) Int. Cl. H01J 5/18; G01J 1/00

(52) U.S. Cl. 250/336.1; 250/505.1

(57) ABSTRACT

A high strength window for a radiation detection system has a plurality of ribs comprising beryllium material. There are openings between the plurality of ribs. The tops of the ribs terminate generally in a common plane. The high strength window also has a support frame around a perimeter of the ribs. A layer of thin polymer film material is disposed over and spans the plurality of ribs and openings to pass radiation therethrough. A radiation detection system comprises a high strength window as described above and a sensor behind the window. The sensor is configured to detect radiation that passes through the window.

### CLAIM OF PRIORITY

This is a continuation-in-part of U.S. patent application Ser. No. 11/756,946, filed on Jun. 1, 2007; which is hereby incorporated herein by reference in its entirety.

### FIELD OF THE INVENTION

The present invention relates generally to radiation detection systems and associated high strength radiation detection windows.

### BACKGROUND

Radiation detection systems are used in connection with detecting and sensing emitted radiation. Such systems can be used in connection with electron microscopy, X-ray telescopy, and X-ray spectroscopy. Radiation detection systems typically include in their structure a radiation detection window, which can pass radiation emitted from the radiation source to a radiation detector or sensor, and can also filter or block undesired radiation.

Standard radiation detection windows typically comprise a sheet of material, which is placed over an opening or entrance to the detector. As a general rule, the thickness of the sheet of material corresponds directly to the ability of the material to pass radiation. Accordingly, it is desirable to provide a sheet of material that is as thin as possible, yet capable of withstanding differential pressure and normal wear and tear.

Since it is desirable to minimize thickness in the sheets of material used to pass radiation, it is often necessary to support the thin sheet of material with a support structure. Known support structures include frames, screens, meshes, ribs, and grids. While useful for providing support to an often thin and fragile sheet of material, many support structures are known to interfere with the passage of radiation through the sheet of material due to the structure's geometry, thickness and/or composition. The interference can be the result of the composition of the material itself, e.g., silicon. Silicon ribs are set forth in U.S. Pat. No. 4,933,557, which is incorporated herein by reference.

X-ray windows are typically used with x-ray detectors. In order to avoid contamination of the x-ray spectra from the sample being measured, it is desirable that, to the maximum extent possible, that x-rays impinging on the x-ray detector are only emitted from the source to be measured. Unfortunately, x-ray windows, including the window support structure, can also fluoresce and thus emit x-rays that can cause contamination lines in the x-ray spectra. Contamination of the x-ray spectra caused by low atomic number elements is less problematic than contamination caused by higher atomic number elements. It is desirable therefore that the window and support structure be made of a material with as low of an atomic number as possible in order to minimize this noise. Silicon, having an atomic number of 14, has often been used. An element with an even lower atomic number than silicon, namely carbon, in the form of a diamond support structure, having an atomic number of 6, has been proposed (see U.S. patent application Ser. No. 11/756,962 which is incorporated herein by reference). Contamination from structures with an atomic number as low as 6, however, is still problematic. Thus it would be desirable to create a support structure of a material with an even lower atomic number than 6.

The support structure can be attached to a window mount, which can be made of metals such as nickel, brass, aluminum, or steel. Sometimes it is desirable for an x-ray window to be able to withstand high temperatures without damage to the window. Stresses in the support structure can result from raising the temperature due to a mismatch of the coefficient of thermal expansion (CTE) between the support structure and a window mount. Due to these stresses, and the inherently brittle characteristic of silicon and diamond, cracks may develop in the support structure, thus weakening the support structure. For example, the CTE for steel is 13.0 but the CTE for diamond is 1.2 and silicon is 5.1 (see Table 1).

The support structure can be attached to a window mount with an adhesive. Some adhesives can have an upper temperature limit that can also result in window failure if the window is raised to a higher temperature. Thus a CTE mismatch between the support structure and the window mount and/or adhesive temperature limitations can result in an upper temperature limit for the window.

### SUMMARY OF THE INVENTION

Accordingly, it has been recognized that it would be advantageous to develop a radiation detection system having a high strength, yet thin, radiation detection window that has the desirable characteristics of good x-ray transmission and minimal x-ray spectra contamination. It has been recognized that it would be advantageous to develop a radiation detection system in which the CTE of the window support structure is closely matched to the CTE of the window mount in order to avoid thermal stresses in the window system as it is raised to higher temperatures. It has also been recognized that it would be advantageous to develop a radiation detection system which is not temperature limited by the adhesive, such as an epoxy, between the window mount and the support structure.

Accordingly, the present invention provides a high strength window for a radiation detection system. The window can include a plurality of ribs comprising a beryllium material. There are openings between the plurality of ribs. The tops of the ribs terminate generally in a common plane. As such, each rib can be substantially the same height as the other ribs.

A support frame can be disposed around a perimeter of the ribs. The support frame can provide stability to the ribs defining the grid and can also provide structure for securing the radiation detection window to other elements in the radiation detection system. A thin film material can be disposed over and span the plurality of ribs and openings. The thin film material is configured to allow radiation to pass therethrough.

The present invention also provides a radiation detection system. The radiation detection system can include a high strength window as described above, and can further include a sensor. The sensor can be configured to detect radiation that passes through the window.

There has thus been outlined, rather broadly, various features of the invention so that the detailed description thereof that follows may be better understood, and so that the present contribution to the art may be better appreciated. Other features of the present invention will become clearer from the following detailed description of the invention, taken together with the accompanying claims, or may be learned by the practice of the invention.

### BRIEF DESCRIPTION OF THE DRAWINGS

FIG. 1 is a cross-sectional view of a high strength window in accordance with an embodiment of the present invention;

FIG. 2 is a cross-sectional schematic view of an x-ray detector system with the window of FIG. 1 in accordance with an embodiment of the present invention;

FIG. 3a is a top view of the high strength window of FIG. 1;

FIG. 3b is a top view of another embodiment of another high strength window in accordance with an embodiment of the present invention;

FIG. 3c is a top view of another embodiment of another high strength window in accordance with an embodiment of the present invention; and

FIG. 3d is a top view of another embodiment of another high strength window in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

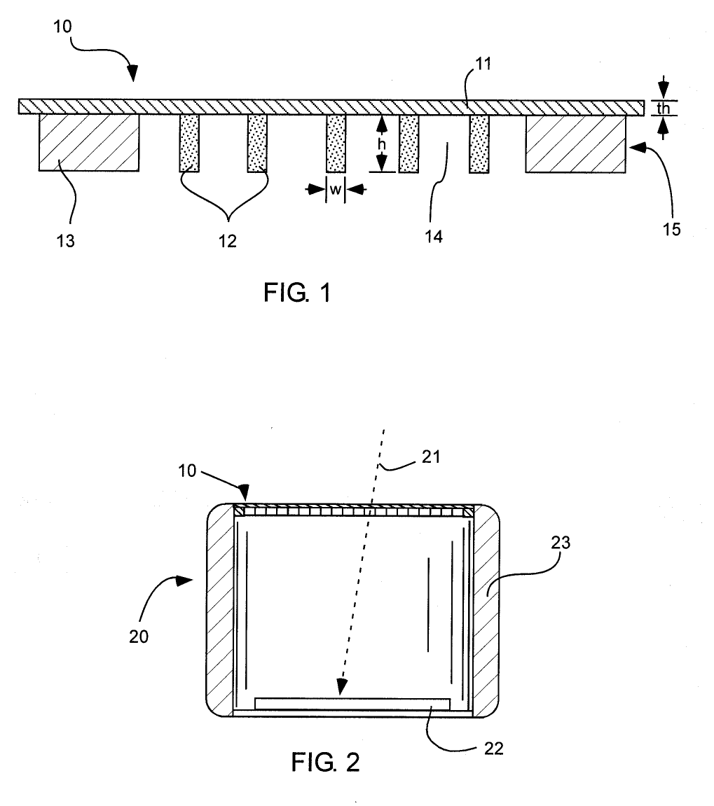

Shown in FIG. 1 is an x-ray window 10. The window includes a support structure which is comprised of a plurality of ribs 12 comprising beryllium, openings 14 between the plurality of ribs, and a support frame 13 around a perimeter of the ribs and carrying the ribs. The tops of the ribs terminate generally in a common plane. The window also includes a layer of thin film material 11 disposed over and spanning the support structure and openings, and capable of passing radiation therethrough.

A support frame 13 is disposed around a perimeter of the ribs 12 and can provide structural support to the ribs and the window in general. The support frame can be made of the same material as the plurality of ribs 12. Accordingly, the support frame can include a beryllium material. In this case, the support frame can be either integral with the ribs and formed from a single piece of material, or can form a separate piece. Alternatively, the support frame can be made of a material that is different from the beryllium material comprising the ribs. The support frame can be configured to secure the window to an appropriate location on a radiation detection system.

The ribs 12, openings 14, and the support frame 13 comprise a support structure 15. The window also has a layer of thin polymer material disposed over and spanning the support structure.

Beryllium has a low atomic number of 4 in order to minimize spectrum contamination which could be caused by x-ray window materials having a higher atomic number. In comparison, silicon and diamond have been proposed for or used as window support structures, but carbon has an atomic number of 6 and silicon has an atomic number of 14. Therefore, use of beryllium ribs having an even lower atomic number can result in less spectrum contamination than carbon or silicon.

The support structure can be attached to a window mount, which can be made of metals such as nickel, brass, aluminum, or steel. Sometimes it is desirable for an x-ray window to be able to withstand high temperatures without damage to the window. Stresses in the support structure can result from raising the temperature due to a mismatch of the coefficient of thermal expansion (CTE) between the support structure and the window mount. Due to these stresses cracks may develop in the support structure, thus weakening the support structure. In addition, the inherently brittle characteristic of silicon and diamond can contribute to such cracks if a silicon or diamond support structure is used. For example, the CTE for steel is 13.0 but the CTE for diamond and silicon are 1.2 and 5.1 respectively (see Table 1). In contrast, the CTE for beryllium is 11.5, much closer to the CTE of steel and other metals typically used for window mounts.

TABLE 1
Coefficient of Thermal Expansion

| | CTE |
|---|---|
| Material | (10−6 m/m K) |
| Aluminum | 22.2 |
| Beryllium | 11.5 |
| Brass | 18.7 |
| Bronze | 18.0 |
| Carbon - diamond | 1.2 |
| Copper | 16.6 |
| Nickel | 13.0 |
| Silicon | 5.1 |
| Steel | 13.0 |
| Tin | 23.4 |
| Zinc | 29.7 |

Silicon and diamond support structures can be attached to a window mount with an adhesive, such as an epoxy. Such adhesives can have an upper temperature limit that can also result in window failure if the window is raised to a higher temperature. Because beryllium is metallic, beryllium can be more readily brazed onto a window mount to form a metallic bond. The brazing process can replace the adhesive as the means of attachment to the window mount. Use of a brazed seal instead of a temperature limited adhesive can allow the window to endure higher temperatures without damage to the window. Other processes, such as diffusion bonding, may be used to create an metallic seal between the support structure and the window mount.

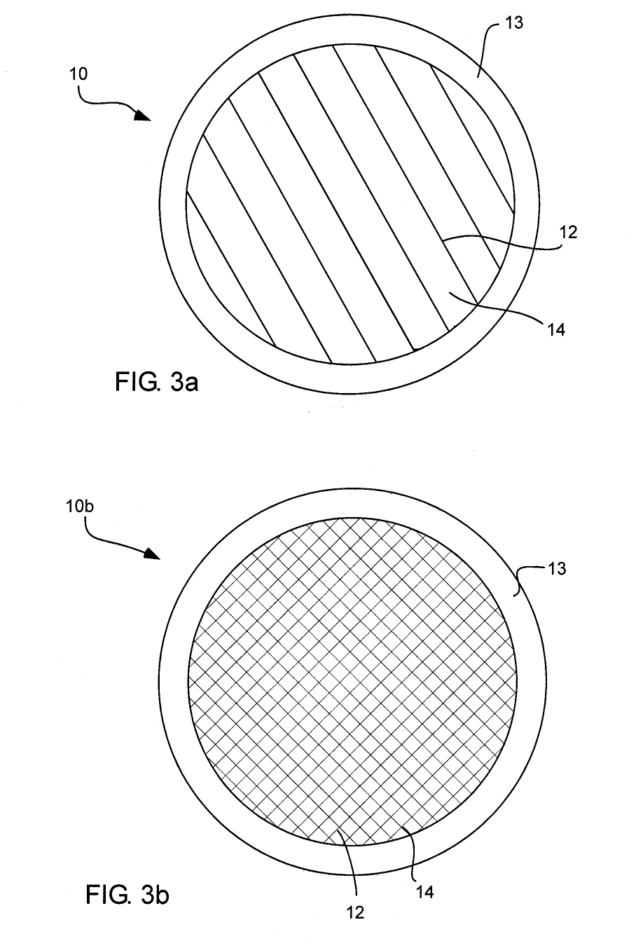

The x-ray window of FIG. 1 can be used in a radiation detection system 20 shown in FIG. 2. The radiation detection system includes a window mount 23 to which the window 10 can be attached. An enclosure surrounds a radiation sensor 22. The enclosure can comprise the window mount 23 and the window 10.

In use, radiation in the form of high energy electrons and high energy photons (indicated by line 21 in FIG. 2) can be directed toward the window of the radiation detection system. The window receives and passes radiation therethrough. Radiation that is passed through the window reaches a sensor 22, which generates a signal based on the type and/or amount of radiation it receives. In order to maximize collection of radiation by the sensor 22, it is desirable that the ribs 12 have a small height h and a small width w. For example, the height of the ribs can range from about 50 μm to about 100 μm.

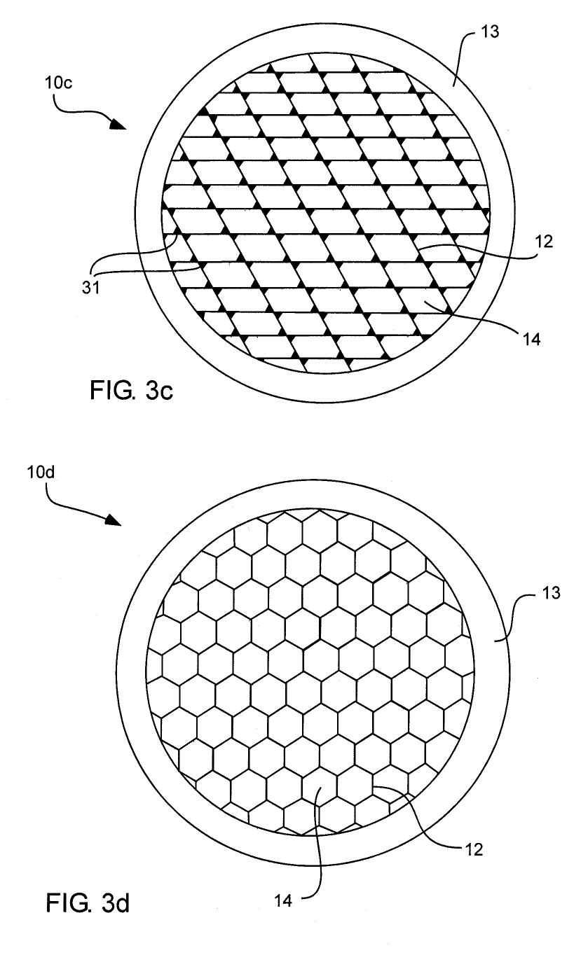

The plurality of ribs 12 can have a variety of different shaped openings. For example, a window 10 comprising a single series of parallel ribs is shown in FIG. 3a. Another window 10b, with a grid of intersecting ribs, is shown in FIG. 3b. The window 10c shown in FIG. 3c shows a plurality of intersecting ribs which are intersect non-perpendicularly with respect to each other and define non-rectangular openings. The window 10d shown in FIG. 3d shows a plurality of intersecting ribs which are intersect non-perpendicularly with respect to each other and define hexagonal-shaped openings. The grid structure shown in FIGS. 3c & 3d is described more fully in U.S. Patent Publication Number 2008/0296518 and is incorporated herein by reference. The present invention is not limited to the arrangements of ribs shown but rather includes other shapes such as circles, ovals, trapezoids, triangles, parallelograms etc.

In any embodiment in which there are intersecting ribs, and shown in FIG. 3c, corners at each intersection may be partially filled 31 with the same material as the ribs. This filling 31 in the corners can strengthen the support structure.

Regardless of the shape of the openings, it is desirable that the openings 14 generally occupy more area within the perimeter of the support frame 13 than the plurality of ribs 12. This is due to the fact that the openings 14 will typically absorb less radiation than the surrounding ribs and radiation can more freely pass through the openings than through the ribs.

In one aspect, the openings take up between about 75% to about 90% of the total area within the perimeter of the support frame. For example, in one embodiment the openings in the grid comprise at least about 75% of the total area within the perimeter of the support frame and the plurality of ribs comprise no more than about 25% of the total area within the perimeter support frame. Alternatively, the openings can comprise at least about 90% of the total area within the support frame, and the plurality of ribs can comprise no more than about 10% of the total area within the frame.

Alternatively, the openings can take up between about 60% to about 75% of the total area within the support frame and the plurality of ribs can take up between about 40% to about 25% of the total area within the support frame. The openings can take up at least 60% of the total area within the support frame and the plurality of ribs can take up no more than 40% of the total area within the support frame. The openings can take up at least 75% of the total area within the support frame and the plurality of ribs can take up no more than 25% of the total area within the support frame. The openings can take up at least 90% of the total area within the support frame and the plurality of ribs can take up no more than 10% of the total area within the support frame.

The thin film can include a layer of polymer material, such as poly-vinyl formal (FORMVAR), butvar, parylene, kevlar, polypropylene, lexan or polyimide. In one aspect, the thin film of polymer material avoids punctures, uneven stretching or localized weakening. To reduce the chance of these undesirable characteristics, the tops of the ribs 12 can be rounded and/or polished to eliminate sharp corners and rough surfaces. The thin film can comprise beryllium.

The thin film should be thick enough to withstand differential pressure and normal wear and tear. However, as thickness of the layer increases so does undesirable absorption of radiation. In one aspect, the film can have a thickness less than about 0.30 μm.

In addition, for thin film corrosion prevention or for prevention of transmission of unwanted electromagnetic radiation, a barrier layer can be disposed on the thin film. The barrier film layer can include boron hydride and/or aluminum. U.S. Pat. No. 5,226,067 describes use of boron hydride, on an x-ray window, for corrosion prevention, and is incorporated herein by reference.

The support structure 15 can be made by photolithography and wet etch. A polymer adhesive, such as an uncured or partially cured polymer, may be used to adhere the thin film 11 to the support structure 15. One method is to dip the support structure in a liquid monomer chemical which is radiation reactive. The layer of thin film may be placed on the polymer adhesive on the support structure. The monomer chemical may be linked to form a polymer by exposure of the chemical to radiation. The polymer adheres the support structure to the thin film layer. Alternatively, the monomer chemical may be partially cured before applying the thin film. The support structure 15 can then be attached to the window mount 23 by brazing, diffusion bonding, or other similar method that results in a metallic seal.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A window for a radiation detection system, the window comprising:
a) a support structure comprising:
i) a plurality of ribs comprising beryllium;
ii) openings between the plurality of ribs;
iii) tops of the ribs terminate generally in a common plane;
iv) a support frame around a perimeter of the ribs and carrying the ribs; and
b) a layer of thin film material disposed over and spanning the support structure and capable of passing radiation therethrough.

2. A window as in claim 1, wherein the openings comprise at least 75% of a total area within the frame, and the plurality of ribs comprise no more than 25% of the total area within the frame.

3. A window as in claim 1, wherein the openings comprise at least 90% of the total area within the frame, and the plurality of ribs comprise no more than 10% of the total area within the frame.

4. A window as in claim 1, wherein the height of the ribs is from about 50 um to about 100 um.

5. A window as in claim 1, wherein a thickness of the film is less than approximately 0.30 μm.

6. A window as in claim 1, wherein the layer of thin film material comprises beryllium.

7. A window as in claim 1, wherein the layer of thin film material comprises a polymer.

8. A window as in claim 1, further comprising a barrier layer disposed over the thin film material.

9. A window as in claim 8, wherein the barrier layer comprises boron hydride.

10. A window as in claim 1, wherein the plurality of ribs and support frame are integrally formed from a single piece of material.

11. A window as in claim 1, wherein:
a) the window further comprises a window mount;
b) the support frame comprises beryllium; and
c) the support frame is sealed to the window mount through a metallic bond.

12. A window as in claim 11, wherein the metallic bond between the support frame and the window mount was formed by a brazing process.

13. A window as in claim 1, wherein:
a) the plurality of ribs are intersecting ribs; and
b) the intersecting ribs are oriented non-perpendicularly with respect to each other and define non-rectangular openings;

14. A window as in claim 13, wherein at least one corner of each opening is partially filled with a same material as the ribs.

15. A window as in claim 13, wherein the openings of the grid are hexagonal.

16. A window as in claim 1, wherein an uncured polymer is used to attach the layer of thin film to the plurality of ribs.

17. A window as in claim 1, wherein a partially cured polymer is used to attach the layer of thin film to the plurality of ribs.

18. A radiation detection system comprising:
a) a window for passing radiation therethrough, the window comprising:
i) a plurality of ribs comprising beryllium;
ii) openings between the plurality of ribs;
iii) tops of the ribs terminate generally in a common plane;
iv) a support frame around a perimeter of the ribs and carrying the ribs; and
v) a layer of thin film material disposed over and spanning the plurality of ribs and openings and capable of passing radiation therethrough; and
b) a sensor behind the window configured to detect radiation that passes through the window.

19. A radiation detection system comprising:
a) a support structure comprising:
i) a plurality of intersecting ribs comprising beryllium;
ii) openings between the plurality of ribs;
iii) tops of the ribs terminate generally in a common plane;
iv) the intersecting ribs being oriented non-perpendicularly with respect to each other and defining non-rectangular openings;
v) a support frame comprising beryllium around a perimeter of the ribs and carrying the ribs; and
b) a layer of thin film material disposed over and spanning the support structure and capable of passing radiation therethrough;
c) a window mount attached to the support frame through a metallic bond; and
d) a sensor behind the thin film material configured to detect radiation that passes through the thin film material.
